(19) United States
(12) Patent Application Publication
(10) Pub. No.: US 2002/0149223 A1
(43) Pub. Date: Oct. 17, 2002

(54) Bed liner comprising assemblable components

(76) Inventors: John R. Saucier, Powell, TN (US); John P. Quirion, Clinton, TN (US); Bruce L. Richard, Andersonville, TN (US)

Correspondence Address: BRINKS HOFER GILSON & LIONE, P.O. BOX 10395, CHICAGO, IL, 60610, US

(21) Appl. No.: 09/832,706

(22) Filed: Apr. 11, 2001

(51) Int. Cl. B62D 33/00

(52) U.S. Cl. 296/39.2

(57) ABSTRACT

A multi-component pickup truck and van liner comprehends a plurality of formed sections which nest compactly for shipment and are readily and easily assembled into a van or bed liner. The liner includes a front end panel having a flange or lip extending along a portion of its edge, left and right sidewall sections which include wheel well portions, partial bottom panels, a center bottom panel having edge flanges and, optionally, a tailgate panel. The bed liner is assembled by overlapping the edge flanges and securing the panels together by suitable fasteners, an adhesive or material both.

### BACKGROUND OF THE INVENTION

1. Field of the Invention

The invention relates generally to liners for pickup truck beds, sport utility vehicles and vans and more particularly to a multi-component bed liner comprising a front panel, two side wall and bottom assemblies and a center bottom panel as well as an optional tailgate panel which may be easily stored, shipped and readily assembled.

2. Description of Related Art

Bed liners for pickup truck beds and liners for vans and sport utility vehicles are a popular OEM and after-market accessory. The liner acts as a buffer between the vehicle bed and the cargo carried therein. As such, they protect the factory finish from abrasion and adverse environmental conditions and disperse impacts such that the appearance, serviceability and structural integrity of the bed is maintained. Furthermore, liners collect and channel off rainwater and other liquids, which may either quickly or over time damage the vehicle bed.

In order to ensure a close fit between the bed and liner and a particular vehicle bed, virtually every bed liner is custom engineered to fit a particular vehicle model. Poorly fitting bed liners or bed liners designed to fit two or more models which may not fit any of the beds as well as is desirable will frequently allow the ingress and collection of rainwater between the liner and vehicle bed. Moreover, if they do not closely conform to the shape of the bed, they may be vulnerable to impact damage in regions unsupported by the bed.

Accordingly, manufacturers typically manufacture single purpose, i.e. designed for a single product application, bed liners and after-market dealers must stock a variety of vehicle-dedicated bed liners in order to satisfy current, diverse market needs. Aside from the obvious issue of inventory value, the space occupied by bed liner inventory can be significant and have a significant impact on dealer overhead.

Shipment of bed liners both to distributors and from distributors to retailers is also challenging. While such liners are typically nested within one another for shipment in multiples and most designs specifically include draft necessary for the molding process, which facilitates such nesting, the unarguable fact is such bed liners are bulky. A bed liner is typically eight feet wide and may be between six and eight feet long or larger. Because of its size, weight and susceptibility to damage in an unsupported condition, single or small volume shipments are discouraged notwithstanding that such shipments would alleviate dealer inventory, storage and overhead issues described above.

The present invention addresses and solves many of these problems.

### SUMMARY OF THE INVENTION

A multi-component pickup truck and van liner comprehends a plurality of formed sections which nest compactly for shipment and are readily and easily assembled into a van or bed liner. The liner includes a front end panel having a flange or lip extending along a portion of its edge, left and right sidewall assemblies which include wheel well portions, partial bottom panels and edge flanges, a center bottom panel having edge flanges and, optionally, a tailgate panel. The bed liner is assembled by overlapping the edge flanges and securing the panels together by suitable fasteners, adhesive material or both. The panels are preferably of molded, high density polyethylene (HDPE) or similar rugged and stable plastic. Because bed liners according to the present invention can be relatively compactly packaged into a cardboard container, ease of shipment is improved, damage during shipment is reduced and dealer inventory and space requirements are reduced with a corresponding reduction in overhead.

It is thus an object of the present invention to provide a multi-component liner for pickup truck beds, sport utility vehicles and vans.

It is a further object of the present invention to provide a multi-component bed liner having a front end panel, left and right sidewall assemblies, a center bottom panel and an optional tailgate panel.

It is still a further object of the present invention to provide a pickup truck, van or sport utility vehicle bed liner comprising multiple, readily assemblable components which is nestable for shipping and which occupies a small portion of the volume of a conventional bed liner.

It is still a further object of the present invention to provide a multi-component pickup truck, van or sport utility vehicle bed liner which can be readily assembled with fasteners, adhesives, or both.

Further objects and advantages of the present invention will become apparent by reference to the following description of the preferred embodiment and appended drawings, wherein like reference numbers refer to the same component, element or feature.

### BRIEF DESCRIPTION OF THE DRAWINGS

FIG. 1 is a perspective view of a multi-component liner according to the present invention disposed in the bed of a pickup truck;

FIG. 2 is an exploded perspective view of a multi-component liner according to the present invention;

FIG. 3 is a full, sectional view of a multi-component liner according to the present invention taken transversely through the wheel well region;

FIG. 4 is a fragmentary, sectional view of a front wall of a multi-component liner according to the present invention taken along line 4-4 of FIG. 2;

FIG. 5 is a fragmentary, sectional view of a sidewall panel assembly according to the present invention taken along line 5-5 of FIG. 2;

FIG. 6 is a fragmentary, sectional view illustrating a manner of attaching components of a liner according to the present invention together;

FIG. 7 is an exploded perspective view of a first alternate embodiment of a multi-component liner according to the present invention.

### DESCRIPTION OF THE PREFERRED AND ALTERNATE EMBODIMENTS

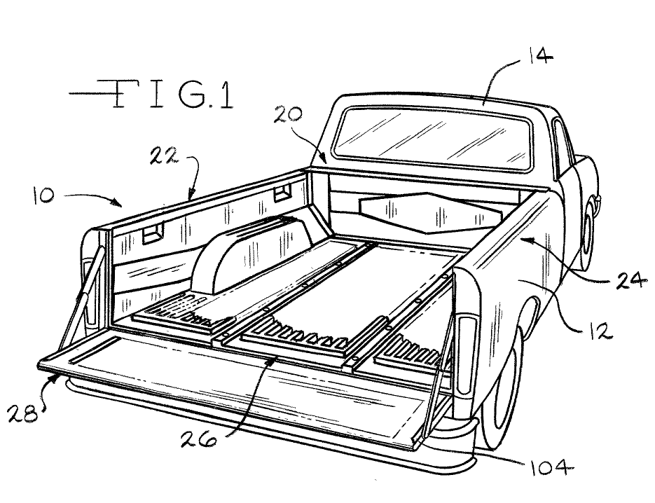

Referring now to FIG. 1, a demountable or knockdown multi-component bed liner is illustrated and generally designated by the reference number 10. The multi-component bed liner 10 is illustrated in place in a truck bed 12 of a typical pickup truck 14. While illustrated within the bed 12 of a pickup truck 14, it will be appreciated that a demountable or knockdown bed liner 10 according to the present invention may be utilized with and is equally suited for service in the cargo area of a sport utility vehicle (SUV), a van, a panel truck or similar motor vehicle.

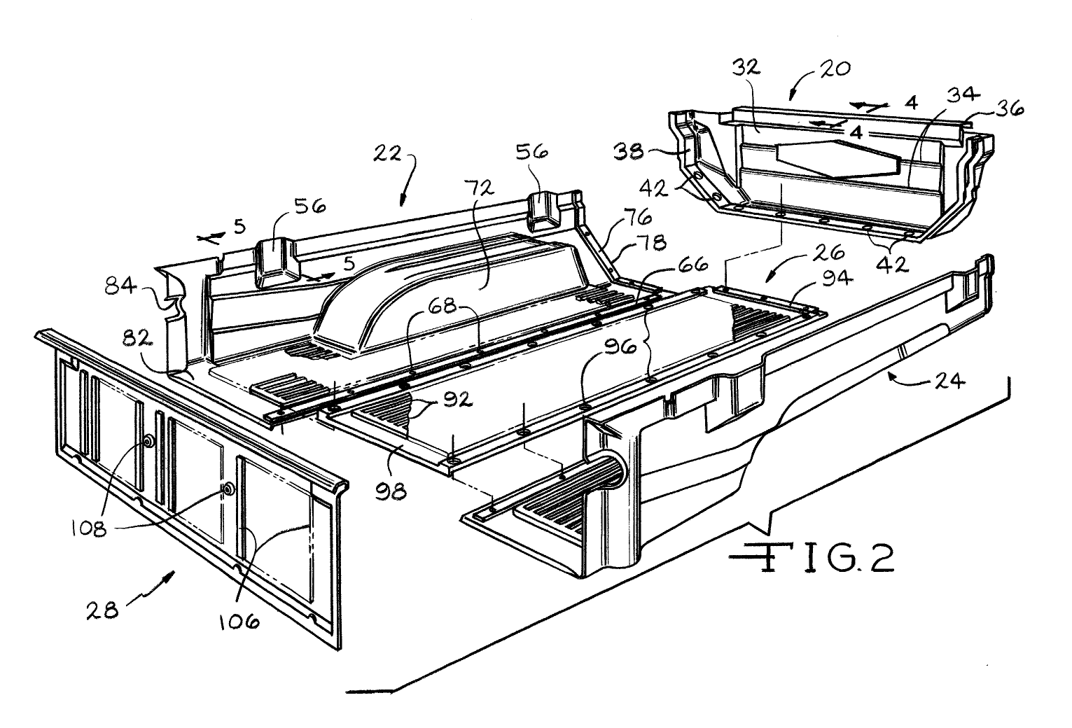

Referring now to FIGS. 1 and 2, the multi-component bed liner 10 preferably includes a forward or front panel assembly 20, a left side assembly 22, a right side assembly 24 which will typically be substantially a mirror image of the left side assembly 22, a center bottom panel 26 and a tailgate panel 28.

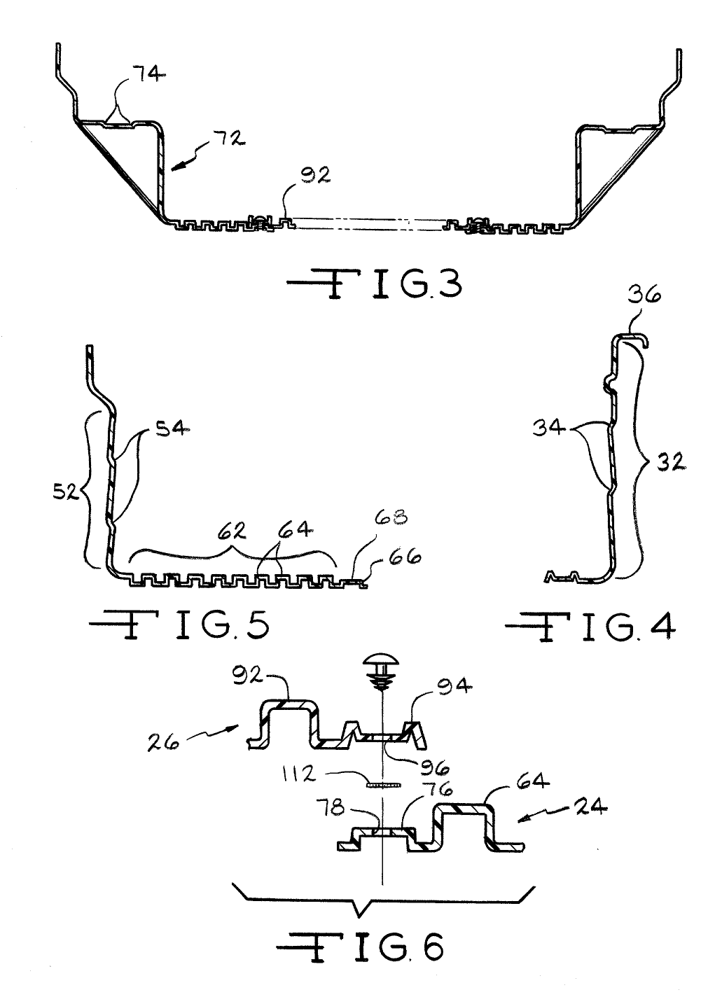

As illustrated in FIGS. 2 and 4, the front panel assembly 20 includes a center body portion 32 preferably defining a plurality of horizontal strengthening shingle-like offsets or ribs 34. At the top of the center body portion 32 is an inverted J-shaped or C-shaped ledge 36 which is sized to engage the forward upper rail of a typical pickup truck bed 12. Such a J-shaped ledge 36 is also desirable from a strengthening and rigidity standpoint in bed liners 10 intended for use in vehicles other than pickup trucks. Extending along the sides and bottom of the front panel assembly 20 is a generally perpendicularly disposed flange or lip 38 having a plurality of spaced-apart, through openings or apertures 42 disposed therealong. The flange or lip 38 may define two generally vertical side sections and a center horizontal section or, as illustrated, vertical side sections and a center horizontal section flanked by diagonal or oblique regions. Alternatively, the vertical and horizontal sections may be interconnected by curved regions. Generally speaking, the configuration of the bed liner 10 will be dictated by the configuration of a particular bed 12 within which the liner 10 is installed. As such, consideration must be given to the size of areas unsupported by the truck bed 12 which may be subject to damage by impact loading. Of equal importance, is the desire to minimize sharp, i.e., perpendicular or rectangular corners which tend to be locations of stress concentration and thus regions of the bed liner 10 which will be most prone to damage by careless loading of the bed liner 10 or shifting loads. Clearly, the final design will typically be a compromise between these two competing design criteria.

Turning now to FIGS. 2, 3 and 5, the left and right sidewall assemblies 22 and 24 will be described. At the outset, it should be appreciated that but for minor details, typically associated with matching the configuration of the particular vehicle bed 12 or interior with which the bed liner 10 is to be utilized, the left sidewall assembly 22 and the right sidewall assembly 24 will be symmetrical, mirror images. Thus, only the left sidewall assembly 22 will be described herein, it being understood that the right sidewall assembly 24, but for minor design differences, will be a mirror image.

The left sidewall assembly 22 includes a generally vertical sidewall 52 having a plurality of strengthening offsets or ribs 54 which define a shingle-like structure and which provide reinforcing and increase the rigidity of the sidewall 52. Appropriately disposed, preferably at two longitudinally spaced apart locations along the upper edge of the sidewall 52, are a pair of pockets 56 which preferably define a width sufficiently great to accept a 2×4 on its side in order to facilitate double stacking of sheet material and other cargo. The left sidewall assembly 22 also includes a bottom wall 62, which extends across a portion, typically approximately one-third, of the bottom of the truck bed 12. The bottom wall 62 includes longitudinally extending corrugations 64 which preferably duplicate the height, width and spacing of corrugations in the truck bed 12 such that the bottom wall 62 closely conforms therewith. At the innermost portion of the bottom wall 62, that is, that longitudinal portion most distant from the sidewall 52 is a narrow, planar strip or flange 66 which includes a plurality of spaced-apart through openings or apertures 68.

Disposed in the region of the intersection between the vertical sidewall 52 and the bottom wall 62 is a wheel well housing 72. The wheel well housing 72 also preferably closely conforms to the shape of the wheel well of the pickup truck 14 or other motor vehicle such that the material of the bed liner 10 is relatively well supported. The wheel well housing 72 may include ribs or offsets 74 which strengthen or reinforce the structure as will be readily appreciated. The forward portion of the left sidewall assembly 22 also includes a lip or flange 76 which corresponds in shape and is complementary in configuration to the flange 38 on the front panel assembly 20. Similarly, the flange 76 includes a plurality of spaced-apart, through openings 78 which align with the openings 42 in the flange 38 of the front panel assembly 20. At the end of the left sidewall assembly 22 opposite the front flange 76 is a flat rear lip or flange 82 which may define, as necessary, cutouts 84 or other structures which adapt the bed liner 10 to a particular vehicle and provide and facilitate a reasonably tight seal against and conform to various features of the truck bed 12.

Referring now to FIGS. 1, 2 and 3, the multi-component bed liner 10 also includes the center bottom panel 26. The center bottom panel 26 extends transversely across approximately one-third of the width of the truck bed 12 of the pickup truck 14. Thus, the width of both of the sidewall assemblies 22 and 24 and the center bottom panel 26 is approximately equal. The center bottom panel 26 includes a plurality of longitudinal corrugations 92 which, in a manner similar to the corrugations 64 in the sidewall panel assemblies 22 and 24 preferably correspond in height, width and spacing to corrugations in the bed 12 of the truck 14 such that the corrugations 92 in the center bottom panel 26 in general are intimately supported thereby. About the periphery of the center bottom panel 26 is a narrow flange or lip 94 having a plurality of spaced-apart through opening or apertures 96 which align with corresponding apertures 42 in the front panel assembly 20 and apertures 68 in the left and right sidewall assemblies 22 and 24. In a fashion similar to the rear lips 82 of the left and right sidewall assemblies 22 and 24, the center bottom panel 26 also includes a flat rear lip or flange 98, which conforms closely to the configuration of the truck bed 12.

Referring now to FIGS. 1 and 2, optionally, though typically, the multi-component bed liner 10 will include a tailgate panel 28. Typically, the tailgate assembly 28 will include a folded, hook or inverted J-shaped edge 102, which engages the upper edge of a tailgate 104 of the pickup truck 14. Typically, as well, the tailgate panel 28 will include a plurality of undulations or ribs 106 which strengthen and reinforce the tailgate assembly 28. Suitable fasteners (not illustrated) extending through a plurality of openings 108 in the tailgate panel 28 secure it to the tailgate 104 as will be readily appreciated.

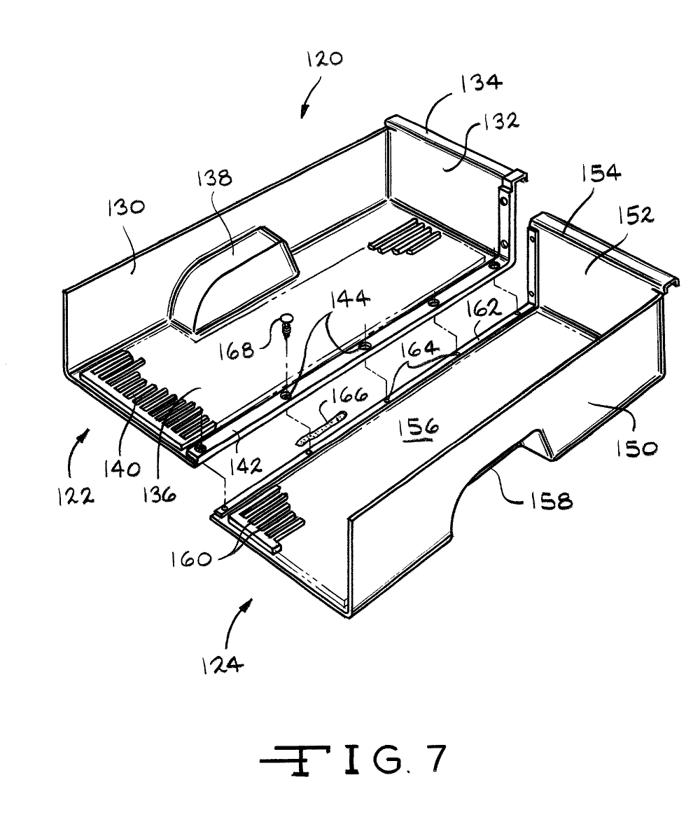

Referring now briefly to FIG. 6, the agency through which the various assemblies of the demountable bed liner 10 are assembled and secured to one another is illustrated. As noted, adjacent portions of the assemblies 20, 22, 24 and 26 include complementary, engageable lips or flanges 38, 66, 76 and 94, respectively, having through aligned apertures 42, 68, 78 and 96. When the assemblies 20, 22, 24 and 26 are positioned as generally illustrated in FIG. 1, the apertures such as the apertures 42, 68, 78 and 96 align. If semi-permanent and watertight assembly is desired, a sealant, caulking or adhesive 112 such as Mac-Tac may be disposed between adjacent surfaces of the flanges 94 and 76. Alternatively, double sided tape may be disposed on the flanges to secure the assemblies together. If temporary or non-watertight assembly is preferable, the adhesive 112 may be omitted. Then, a plurality of fasteners 114, such as Christmas tree fasteners or similar readily insertable and removable fasteners such as self tapping screws, are driven into the apertures 42, 68, 78 and 96, thereby securing the adjacent panel assemblies together. If permanent assembly is desired, effectively converting the bed liner 10 into a single piece bed liner, epoxy resins, non-removable mechanical fasteners or autogenous bonding accomplished by heating through the application of thermal, radio frequency (RF) or other energy may be utilized.

Referring now to FIG. 7, a first alternate embodiment demountable bed liner assembly is illustrated and generally designated by the reference number 120. The first alternate embodiment demountable bed liner assembly 120 includes a first or left section 122 and a second or right section 124. The left section 122 and the right section 124 preferably represent left and right halves of a complete bed liner, that is, a bed liner which is fabricated in two sections and assemblable along a longitudinal center line. The left section 122 includes a vertical, longitudinally extending left sidewall panel 130 and a perpendicularly disposed vertical, partial front panel 132 having an inverted J-shaped or C-shaped transversely extending flange or lip 134. Disposed perpendicularly to both the sidewall panel 130 and the front panel 132 is a bottom panel 136. A wheel well housing 138 is disposed at the intersection of the sidewall panel 130 and the bottom panel 136. The bottom panel 136 defines a plurality of longitudinally oriented corrugations 140 which are complementary to corrugations (not illustrated) in a truck bed as explained above. Along the right edge of the bottom panel 136 opposite the left sidewall 130 is a flange or lip 142 having a plurality of spaced-apart through openings or apertures 144.

The right section 124 is essentially a mirror image of the left section 122 and thus includes a right vertical sidewall panel 150, a vertical front panel 152 having an inverted J-shaped or C-shaped lip or flange 154, a bottom panel 156, a wheel well housing 158, a plurality of longitudinal corrugations 160, a flange 162 and a plurality of spaced-apart through openings or apertures 164 in the flange 162.

As will be readily appreciated, the left section 122 and the right section 124 mate along the flanges 142 and 162 which are placed adjacent one another with the apertures 144 and 164 in alignment. If desired, a sealant, caulking, adhesive or double-sided tape 166 may be placed between the adjacently disposed flanges 144 and 164 and mechanical fasteners 168 such as Christmas tree fasteners or self-threading or other comparable removable or non-removable mechanical fasteners may be utilized.

It will also be appreciated that the sections 122 and 124 of the first alternate embodiment demountable bed liner assembly 120 can be substantially nested within one another to reduce the volume of the bed liner assembly 120 in pre-assembly configuration. Depending upon the total length of sections 122 and 124 as well as the precise longitudinal location of the wheel well housings 138 and 158, one of the sections may be reversed end for end, that is, rotated 180° about a vertical axis, such that wheel well housings 138 and 158 may be nested. Depending upon the dimensions and positions described above, such a nested arrangement may represent a more efficient packaging and shipping configuration than if the sections 122 and 124 are slid transversely together from an initial position similar to that illustrated in FIG. 7. It will also be appreciated that while the first alternate embodiment demountable bed liner assembly 120 does not represent the compact storage and shipping configuration achievable by the preferred embodiment bed liner assembly 10, it does represent a significant reduction in size for shipping and storage relative to a single piece, conventional bed liner. Additionally, assembly is somewhat simpler as only two components must be assembled.

As noted above, the panels, sections and assemblies of the preferred and alternate embodiment bed liners 10 and 120 are preferably vacuum molded of high density polyethylene (HDPE) or other rugged, temperature stable and UV resistant plastic. Both single layer sheets of homogeneous material or co-extruded twin layer sheets of two distinct grades or qualities of plastic also may be used to practice this invention. It will be appreciated that fiber reinforced plastics (FRP) are also suitable.

As also noted above, it is anticipated that a bed liner according to the present invention may be nested and readily placed within a suitably sized rectangular cardboard carton. In the case of the preferred embodiment bed liner 10, the carton will have a width of slightly more than 2.5 feet (0.76 m) and a length approximately equal to the length of the bed liner 10. Such dimensions facilitate shipment by many methods and carriers which are neither available nor sensible for a conventional, single piece bed liner.

The foregoing disclosure is the best mode devised by the inventors for practicing this invention. It is apparent, however, that apparatus and methods incorporating modifications and variations will be obvious to one skilled in the art of bed liners. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

We claim:

1. A multi-component liner for a cargo area of a motor vehicle comprising, in combination,
a front panel,
a left side assembly including a left sidewall panel and a left bottom panel,
a right side assembly including a right sidewall panel and a right bottom panel, and
a center bottom panel,
whereby said front panel is secured to said left and right side assemblies and said bottom panel is secured to said left and right side assemblies.

2. The multi-component liner of claim 1 wherein said front panel includes an inverted J-shaped lip adapted to engage a transverse component of a truck bed.

3. The multi-component liner of claim 1 wherein said bottom panels include longitudinal corrugations.

4. The multi-component liner of claim 1 wherein said front panel, said bottom panel and said left and right side assemblies include flanges and said flanges define through openings.

5. The multi-component liner of claim 1 wherein said front panel, said left sidewall and said right sidewall include horizontal ribs.

6. The multi-component liner of claim 1 wherein said left side assembly and said right side assembly include wheel well regions adapted to engage correspondingly shaped and disposed wheel wells in a vehicle.

7. The multi-component liner of claim 1 further including means for securing said panels and assemblies together.

8. The multi-component liner of claim 7 wherein said means for securing includes mechanical fasteners.

9. The multi-component liner of claim 1 further including pockets disposed in said left sidewall and said right sidewall adapted to receive transverse supports.

10. A multi-component liner for a cargo area of a motor vehicle comprising, in combination,
a front panel,
a left side assembly including a left sidewall panel and a left bottom panel having a right longitudinal flange,
a right side assembly including a right sidewall panel and a right bottom panel having a left longitudinal flange,
a center bottom panel having two longitudinal flanges, and
a plurality of fasteners for securing said panels and assemblies together.

11. The multi-component bed liner of claim 10 wherein said bottom panels include longitudinal corrugations.

12. The multi-component bed liner of claim 10 wherein said front panel, said left sidewall and said right sidewall include horizontal ribs.

13. The multi-component bed liner of claim 10 wherein said left side assembly and said right side assembly include wheel well regions adapted to engage correspondingly shaped and disposed wheel wells in a vehicle.

14. The multi-component bed liner of claim 10 wherein said fasteners are Christmas tree fasteners.

15. The multi-component bed liner of claim 10 further including adhesive material for securing said panels and assemblies together.

16. A multi-component liner for a cargo area of a motor vehicle comprising, in combination,
a front panel,
a left side assembly including a left sidewall panel and a left bottom panel, said left bottom panel including longitudinal corrugations and a longitudinal flange,
a right side assembly including a right sidewall panel and a right bottom panel, said right bottom panel including longitudinal corrugations and a longitudinal flange,
a center bottom panel including longitudinal corrugations and a pair of longitudinal flanges, and
means for securing said panels and assemblies together.

17. The multi-component liner of claim 16 wherein said left side assembly and said right side assembly include wheel well regions adapted to engage correspondingly shaped and disposed wheel wells in a vehicle.

18. The multi-component liner of claim 16 wherein said means for securing includes mechanical fasteners.

19. The multi-component liner of claim 16 wherein said means for securing includes adhesive material.

20. The multi-component liner of claim 16 further including pockets disposed in said left sidewall and said right sidewall adapted to receive transverse supports.
